(19) United States
(12) Patent Application Publication
(10) Pub. No.: US 2019/0286167 A1
(43) Pub. Date: Sep. 19, 2019

(54) SYSTEMS AND METHODS FOR PROVIDING MULTIPLE STRAPDOWN SOLUTIONS IN ONE ATTITUDE AND HEADING REFERENCE SYSTEM (AHRS)

(71) Applicant: L3 Technologies, Inc., New York, NY (US)

(72) Inventor: David D. Haaland, Grand Rapids, MI (US)

(73) Assignee: L3 Technologies, Inc., New York, NY (US)

(21) Appl. No.: 16/352,423

(22) Filed: Mar. 13, 2019

Related U.S. Application Data
(60) Provisional application No. 62/642,324, filed on Mar. 13, 2018.

(51) Int. Cl. G05D 1/08; G05D 1/10; B64C 39/02; G01C 21/18

(52) U.S. Cl. CPC G05D 1/0825; G05D 1/101; B64C 2201/12; G01C 21/18; B64C 39/024

(57) ABSTRACT

Various systems benefit from suitable mechanisms and methods for dealing with sensor inaccuracy. For example, various attitude and heading reference system (AHRS) approaches may benefit from systems and methods for providing multiple strapdown solutions. A system can include a plurality of three-axis sensors configured to measure physical quantities (e.g. acceleration, rotational rate), from which can be computed roll, pitch, and heading for a device. The system can also include a controller configured to receive output of the plurality of three-axis sensors as a plurality of inputs, determine a plurality of strapdown solutions each solution of the plurality of solutions based on respective output of the plurality of three-axis sensors, each of which consists of roll, pitch, and possibly heading, weight each output of the plurality of output solutions based on a relation between a given output solution and the other output solutions of the plurality of solutions, and report the roll, pitch, and heading of the device.

### CROSS-REFERENCE TO RELATED APPLICATION

This application is a non-provisional of, and claims the benefit and priority of, U.S. Provisional Patent Application No. 62/642,324, filed Mar. 13, 2018, the entirety of which is hereby incorporated herein by reference.

### BACKGROUND

### Field

Various systems benefit from suitable mechanisms and methods for dealing with sensor inaccuracy. For example, various attitude and heading reference system (AHRS) approaches may benefit from systems and methods for providing multiple strapdown solutions.

### Related Art

An inertial strapdown system may use rate sensors and accelerometers to compute, among other things, roll, pitch, and heading, and in some cases position. If one of these sensors fails, or is not accurate enough for any reason, for example due to a noise source, the attitude (roll and pitch) and heading may become either invalid or inaccurate.

Built-In-Test (BIT) can detect sensor failures and mark the output as failed when a sensor fails its BIT. One shortcoming of such solutions is the loss of attitude/heading when a sensor fails in the field. Furthermore, a BIT is difficult to design such that the attitude/heading solution is marked as invalid before it becomes highly inaccurate, but is not needlessly marked as invalid. In other words, it is hard to balance between trusting inaccurate data (BIT doesn't fail when it should) and generating false or spurious reports of failure (BIT fails when it shouldn't).

### SUMMARY

According to certain embodiments, a system can include a plurality of three-axis sensors configured to measure roll, pitch, and heading for a device. The system can also include a controller configured to receive output of the plurality of three-axis sensors as a plurality of inputs, determine a plurality of strapdown solutions each solution of the plurality of solutions based on respective output of the plurality of three-axis sensors, weight each output of the plurality of output solutions based on a relation between a given output solution and the other output solutions of the plurality of solutions, and report the roll, pitch, and heading of the device.

In certain embodiments, a method can include receiving, at a controller, output of a plurality of three-axis sensors configured to measure physical quantities (e.g. acceleration, rotational rate), from which can be computed roll, pitch, and heading for a device. The method can also include determining, by the controller, a plurality of solutions each solution of the plurality of solutions based on respective output of the plurality of three-axis sensors. The method can further include weighting, by the controller, each of the plurality of solutions based on a relation between a given solution and the other solutions of the plurality of solutions. The method can additionally include reporting, by the controller, the roll, pitch, and heading of the device.

A non-transitory computer-readable medium, according to certain embodiments, can be encoded with instructions that, when executed in hardware, perform a process. The process can include receiving, at a controller, output of a plurality of three-axis sensors configured to measure physical quantities (e.g. acceleration, rotational rate), from which can be computed roll, pitch, and heading for a device. The process can also include determining, by the controller, a plurality of solutions each solution of the plurality of solutions based on respective output of the plurality of three-axis sensors. The process can further include weighting, by the controller, each of the plurality of solutions based on a relation between a given solution and the other solutions of the plurality of solutions. The process can additionally include reporting, by the controller, the roll, pitch, and heading of the device.

### BRIEF DESCRIPTION OF THE DRAWINGS

The accompanying drawings are provided for purposes of illustration and not by way of limitation.

FIG. 1 illustrates a system according to certain embodiments.

FIG. 2 illustrates a method according to certain embodiments.

### DETAILED DESCRIPTION

Certain embodiments of the present invention can achieve additional reliability for inertial strapdown systems using multiple redundant sensors. If multiple sensors are used (for example, multiple three-axis rate sensors, multiple accelerometers, both, or any other desired multiple sensors), and multiple strapdown solutions are calculated, the resulting roll, pitch, heading and any other desired values can be combined by a weighted average, or any other desired algorithm, to compute a more reliable output than one that depends on just one of each type of sensor.

Certain embodiments of the present invention may enhance reliability in at least two ways: (1) the solution may be less affected by noise in the sensors, because the sensors' noise may, to a certain extent, cancel each other out and (2) a Built-In-Test can be done by simply comparing the output roll, pitch, and heading, and if one strapdown solution differs from the others by some threshold amount, that solution can be ignored in the combined output. The combined output need not be invalidated just because one or more of the solutions is not used. As long as a sufficient minimum number of solutions agree with each other, the combined output can be considered valid. In this way, redundancy of multiple inertial systems may be achieved within one inertial product.

Certain embodiments of the present invention may be used with avionics, space vehicles, guided weapons, such as missiles, hand-held devices, or any other application which may use an inertial strapdown solution for computing one or more of roll, pitch, heading, position (or any other desired parameter).

Sensor Arrangement

Embodiments of the present invention may implement multiple strapdown solutions in a single Attitude and Heading Reference System (AHRS) product (or, if desired, in multiple AHRS products). Embodiments of the present invention may provide a product that may contain multiple sets of three rate sensors: x, y, and z. Each set of x, y, and z may be in a single three-axis package, or it may include three separate packages that may be arranged orthogonally. The multiple sets of three may be arranged to have all of their x axes parallel, y axes parallel, etc. Alternatively, they may be arranged to have the first sensor's positive x axis parallel to the second sensor's positive y axis, the first sensor's positive y axis parallel to the second sensor's negative x axis, and so on. They may even be arranged in a non-parallel manner, for instance, one x axis may point into the middle of the first (or second, or third, etc.) octant of another three-axis triad. In all these cases, the rates generated from the sensors can be mathematically rotated to provide multiple rate vectors in the same three-dimensional Cartesian reference system. The number of x-y-z triads could be increased by combining axes from different sensor triads. For instance, the x axis from sensor 1 with the y and z axes from sensor 2. In this manner, as many as eight different three-dimensional rate vectors could be generated from two three-axis sensor triads. Each three-dimensional rate vector may then be fed into its own strapdown algorithm to compute its own set of roll and pitch (and heading, if a heading reference, such as a magnetometer, is provided).

Combining the Outputs of the Individual Strapdown Solutions when One Sensor (of the Many) Fails

As long as all of the sensor triads are providing accurate, valid data, the combining of the strapdown outputs (e.g., roll, pitch and heading) can be straightforward: they can simply be averaged. However, if one sensor triad fails, there may be a graceful way to drop this sensor's strapdown solution from the average without causing steps in the output. In other words, the output, roll, pitch and heading, can be smooth as the combined solution transitions from using all of the sensors, to using all except one triad.

Certain embodiments of the present invention propose a solution that may utilize a weighted average or any other suitable solution. At each iteration of a new output (e.g., roll, pitch and heading), the median of the strapdown outputs may be computed. All solutions that are within some defined limit (e.g., call it limit 1) of the median may receive a weight of 1. As the difference between a particular solution and the median moves from limit 1 to some outer limit (e.g., limit 2), the weight may transition from 1 to zero (e.g., it could go linearly between 1 and zero, or by some non-linear formula or any other desired transition). When the difference is beyond limit 2, that solution may have a weight of zero, and may not be included in the combined solution. One reason for using the median instead of the mean may be that as one solution begins to move away from the others, the median does not move off with it, whereas the mean does.

Circular Median and Circular Weighted Mean

Note that for roll and heading, a circular version of the median and weighted mean may be computed (the unweighted circular mean is in the public domain, and information about it is readily available). A circular median may be computed by taking the sine and cosine of all the angles, finding the median of the sines and cosines, and computing the quadrant-specific arctangent using the median sine and cosine. A weighted circular mean may be computed by taking the sines and cosines of all the angles, and computing a weighted mean of the sines and cosines. Then, the quadrant-specific arctangent may be computed from the weighted mean of the sines and the weighted mean of the cosines. For pitch, a simple median and weighted mean can be used, or a circular version. This is because the range for pitch is only +/−90 degrees.

Output Validity

In this scheme, the attitude validity may be determined not by testing the individual sensors, but by comparing the output attitude/heading solutions. If one solution begins to drift away from the others, it may be dropped—gradually phased out by the weighting scheme described above (or any other suitable scheme). In order for the combined solution to remain valid, a minimum number of solutions can be established, and that minimum number of solutions should be within some minimum range of the median (described above). Heading validity may be established separately from roll/pitch validity, because in some installations there may be no heading reference (such as a magnetometer), so the system outputs roll and pitch.

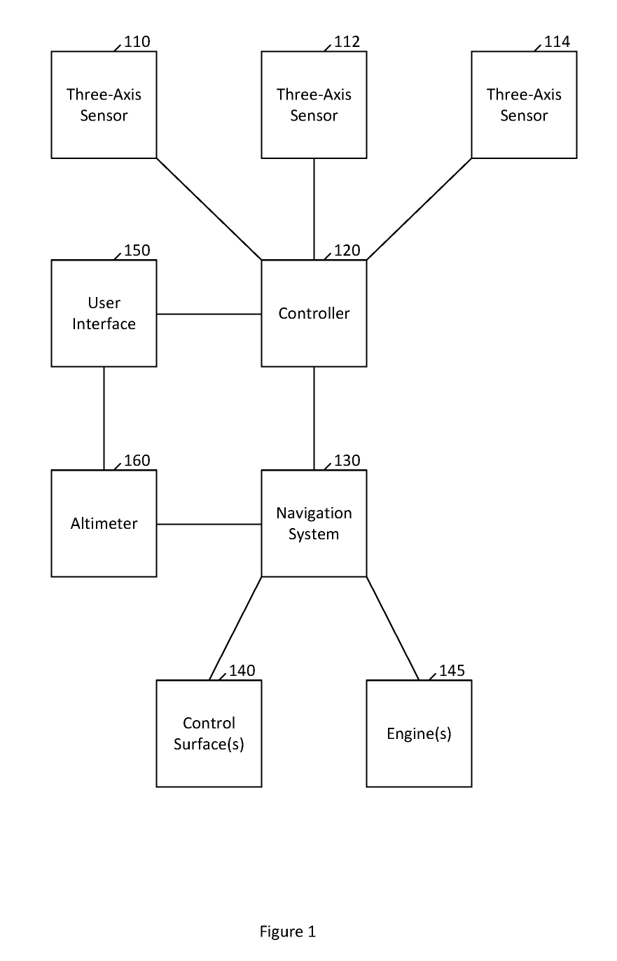

FIG. 1 illustrates a system according to certain embodiments. As shown in FIG. 1, a system can include a plurality three-axis sensors 110, 112, 114. There can be more or fewer than three such sensors. Moreover, the sensors may be other kinds of sensors, such as two-axis sensors or eight-axis sensors. These sensors, therefore, are provided as an illustration and not by way of limitation.

Each of sensors 110, 112, 114 may be a strapdown sensor. A strapdown sensor may be a sensor that does not require an inertial platform as a mounting point, but may be strapped down at any desired place on a vehicle. The particular mounting mechanism of strapping with straps is not required. Optionally, sensors 110, 112, 114 may be mounted to a rotating platform.

The system can also include controller 120. Controller 120 can be any suitable hardware device, such as an application specific integrated circuit (ASIC) or central processing unit (CPU). For example, controller 120 may be one or more chip in a line replaceable unit (LRU). In certain embodiments, controller 120 may be packaged together with the sensors 110, 112, 114. Alternatively, or in addition, the controller 120 may be part of a vehicle guidance system of a vehicle. The vehicle may be, for example, an unmanned aerial vehicle (UAV) or other vehicle.

Controller 120 may be configured to receive as inputs the outputs of sensors 110, 112, 114. The sensors 110, 112, 114 may provide raw outputs or signals representative of roll, pitch, and optionally heading. The sensors 110, 112, 114 may provide roll, pitch, and heading in a coordinate system of the corresponding sensor. The controller 120 may then be calibrated to interpret the sensor data with a predetermined motion of the device, by comparison to other known values, or any other desired way.

Optionally, the controller 120 may determine a plurality of strapdown solutions. Each strapdown solution may provide roll and pitch. Optionally, each strapdown solution may also include heading. The controller 120 may weight each solution, or part thereof, based on a relation between a given output and the other outputs.

There are various ways that this weighting can be done. For example, the controller 120 may determine a median of the solutions, and may weight each solution based on a relation between a given input and the mean. The controller 120 may then determine roll, pitch, and heading for the device based on the weighted plurality of inputs.

In certain embodiments, the weighting can take account of the roll and pitch separately, while in other embodiments, roll and pitch can be weighted together. In certain embodiments, heading may be performed by a different underlying sensor type. Thus, in certain embodiments, the heading may be weighted separately from pitch and roll, even when pitch and roll are weighted together.

The controller can be configured to weight a given solution with a weight of 1 when the given solution is within a first predetermined threshold of the median. The controller can be configured to weight the given solutions with a weight that scales from 1 to 0 when the given solution is beyond the first predetermined threshold of the median but within a second predetermined threshold of the median. This scaling can be a linear scale or any other desired scale. The use of a linear scale may permit a relatively smooth and graceful transition from a solution being considered and a solution being eliminated. The controller can be configured to weight the solution with a weight of 0 when the given output input is beyond the second predetermined threshold of the median. This can be a way in which the solution can be considered as invalid.

After a predetermined time of a sensor's solution being weighted as zero, that solution can be removed from consideration, even as to determining a median. In some cases, this may mean removing the entire sensor from consideration or merely removing a particular roll, pitch, or heading solution from consideration. In certain embodiments, the heading solution may be removed from consideration while the roll and pitch solutions may continue to be considered. This approach may have an advantage of permitting sensors to continue in partial use.

The median of at least one of the roll, the pitch, or the heading can be determined by computing a circular median or mean, as explained above. This calculation can be performed by the controller 120.

The controller 120 can report the roll, pitch, and heading of the device, for example to a navigation system 130 of the device. The navigation system 130 of the device may, for example, be an autopilot system. The navigation system 130 may include its own memory, processors, computer program instructions, and the like. Alternatively, the navigation system 130 may integrated with the controller 120 as a single unit, including by way of example only as a single chip.

The navigational system 130 may, based on output of the controller, provide commands to control surface(s) 140 of the device and/or provide commands to engine(s) 145 of the device. For example, the navigational system 130 may determine that a roll, pitch, or heading of the device should be altered, and consequently may send a message to a rudder, as an example of control surface(s) 140, to change positions. In a copter-based implementation, such as a quadcopter or any other multirotor helicopter, the engine(s) 145 may similarly have their speed adjusted by the navigation system 130 to correct a roll, pitch, or heading to a desired roll, pitch, or heading based on information provided from the controller 120 based on data sourced by three-axis sensors 110, 112, 114.

The controller 120 may also provide information 120 based on data sourced by three-axis sensors 110, 112, 114 to at least one user interface 150 may be a navigational display either in the device (as shown in FIG. 1) or remote from the device (not pictured). The user interface 150 may have its own graphics card, display, processor, and memory, or may be integrated with the controller 120. The user interface 150 may use the information from controller 120 to display the device and/or the environment of the device in an appropriate attitude. The user interface 150 and navigation system 130 may get additional information from other units, such as from an altimeter 160, which may be a barometric altimeter.

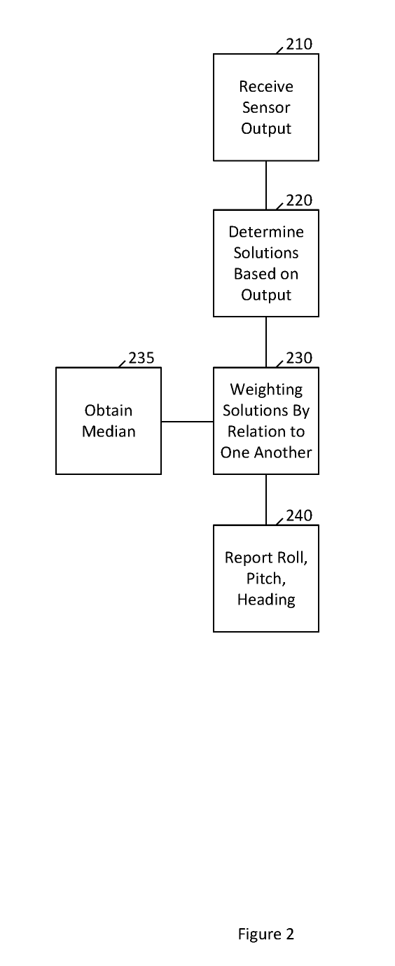

FIG. 2 illustrates a method according to certain embodiments. The method of FIG. 2 may, for example, be implemented using the system of FIG. 1. The method of FIG. 2 can include, at 210, receiving, at a controller, output of a plurality of three-axis sensors configured to measure physical quantities (e.g. acceleration, rotational rate), from which can be computed roll, pitch, and heading for a device. This may be controller 120 and sensors 110, 112, and 114 in FIG. 1, for example.

The method of FIG. 2 can also include, at 220, determining, by the controller, a plurality of solutions each solution of the plurality of solutions based on respective output of the plurality of three-axis sensors. The method can further include, at 230, weighting, by the controller, each of the plurality of solutions based on a relation between a given solution and the other solutions of the plurality of solutions. The weighting can be performed separately for heading.

The method can additionally include, at 240, reporting, by the controller, the roll, pitch, and heading of the device. In certain embodiments, only the roll and pitch may be reported. The reporting can include reporting the roll, pitch, and heading of the device to a navigation system, to a user interface of an aircraft, or to both. Reporting to other devices is also permitted.

The method can include, at 235, obtaining a median of the plurality of solutions. Thus, the relation by which the weighting occurs can be a relation to the median. The median of at least one of the roll, the pitch, or the heading can be determined by computing a circular median or circular mean, as described above.

The weighting can include weighting a given solution of the plurality of solutions with a weight of 1 when the given solution is within a first predetermined threshold of the median. The weighting can also include weighting the given solution of the plurality of solutions with a weight that scales from 1 to 0 when the given solution is beyond the first predetermined threshold of the median but within a second predetermined threshold of the median. The weighting can further include weighting the given solution of the plurality of solutions with a weight of 0 when the given solution is beyond the second predetermined threshold of the median.

The above description has focused on a practical implementation in an aircraft, such as a UAV. Nevertheless, certain embodiments could be used in a variety of manned and unmanned aircraft, including rotorcraft, spacecraft, UAVs, and missiles, in a variety of manned and unmanned watercraft, including surface craft, hovercraft, and submarines, and in hand-held devices. Other practical implementations and use cases are also permitted.

What is claimed is:

1. A system, comprising:
a plurality of three-axis sensors configured to measure physical quantities from which can be computed roll, pitch, and heading for a device;
a controller configured to
receive output of the plurality of three-axis sensors,
determine a plurality of solutions each solution of the plurality of solutions based on respective output of the plurality of three-axis sensors,
weight each of the plurality of solutions based on a relation between a given solution and the other solutions of the plurality of solutions, and
report the roll, pitch, and heading of the device.

2. The system of claim 1, wherein the controller is configured to obtain a median of the plurality of solutions, wherein the relation comprises a relation to the median.

3. The system of claim 2, wherein the controller is configured to weight a given solution of the plurality of solutions with a weight of 1 when the given solution is within a first predetermined threshold of the median.

4. The system of claim 3, wherein the controller is configured to weight the given solution of the plurality of solutions with a weight that scales from 1 to 0 when the given solution is beyond the first predetermined threshold of the median but within a second predetermined threshold of the median.

5. The system of claim 4, wherein the controller is configured to weight the given solution of the plurality of solutions with a weight of 0 when the given solution is beyond the second predetermined threshold of the median.

6. The system of claim 2, wherein the median of at least one of the roll, the pitch, or the heading is determined by computing a circular median or circular mean.

7. The system of claim 1, wherein the controller is configured to determine weighting separately for heading.

8. The system of claim 1, wherein the controller is configured to report the roll, pitch, and heading of the device to a navigation system.

9. The system of claim 1, wherein the controller is configured to report the roll, pitch, and heading of the device to a user interface of an aircraft.

10. The system of claim 1, wherein the device comprises an unmanned aerial vehicle.

11. A method, comprising:
receiving, at a controller, output of a plurality of three-axis sensors configured to measure physical quantities from which can be computed roll, pitch, and heading for a device,
determining, by the controller, a plurality of solutions each solution of the plurality of solutions based on respective output of the plurality of three-axis sensors,
weighting, by the controller, each of the plurality of solutions based on a relation between a given solution and the other solutions of the plurality of solutions, and
reporting, by the controller, the roll, pitch, and heading of the device.

12. The method of claim 11, further comprising:
obtaining a median of the plurality of solutions, wherein the relation comprises a relation to the median.

13. The method of claim 12, wherein the weighting comprises weighting a given solution of the plurality of solutions with a weight of 1 when the given solution is within a first predetermined threshold of the median.

14. The method of claim 13, wherein the weighting comprises weighting the given solution of the plurality of solutions with a weight that scales from 1 to 0 when the given solution is beyond the first predetermined threshold of the median but within a second predetermined threshold of the median.

15. The method of claim 14, wherein the weighting comprises weighting the given solution of the plurality of solutions with a weight of 0 when the given solution is beyond the second predetermined threshold of the median.

16. The method of claim 11, wherein the median of at least one of the roll, the pitch, or the heading is determined by computing a circular median or circular mean.

17. The method of claim 1, wherein the weighting comprises weighting separately for heading.

18. The method of claim 1, wherein the reporting comprises reporting the roll, pitch, and heading of the device to a navigation system.

19. The method of claim 1, wherein the reporting comprises reporting the roll, pitch, and heading of the device to a user interface of an aircraft.

20. A non-transitory computer-readable medium encoded with instructions that, when executed in hardware, perform a process, the process comprising:
receiving, at a controller, output of a plurality of three-axis sensors configured to measure physical quantities from which can be computed roll, pitch, and heading for a device,
determining, by the controller, a plurality of solutions each solution of the plurality of solutions based on respective output of the plurality of three-axis sensors,
weighting, by the controller, each of the plurality of solutions based on a relation between a given solution and the other solutions of the plurality of solutions, and
reporting, by the controller, the roll, pitch, and heading of the device.
